(19) United States
(12) Patent Application Publication
(10) Pub. No.: US 2017/0258121 A1
(43) Pub. Date: Sep. 14, 2017

(54) GLYCOSIDE COMPOSITIONS

(71) Applicant: Cargill, Incorporated, Wayzata, MN (US)

(72) Inventors: Brian D. Guthrie, Chanhassen, MN (US); Michael Alan Mortenson, Rogers, MN (US); Sean Acie Smith, Minneapolis, MN (US)

(73) Assignee: Cargill, Incorporated, Wayzata, MN (US)

(21) Appl. No.: 15/529,292

(22) PCT Filed: Nov. 24, 2015
(86) PCT No.: PCT/US2015/062310

§ 371 Date: May 24, 2017

Related U.S. Application Data
(60) Provisional application No. 62/083,651, filed on Nov. 24, 2014.

(51) Int. Cl. A23L 27/30; A23L 2/60

(52) U.S. Cl. CPC A23L 27/36; A23L 2/60; A23V 2002/00

(57) ABSTRACT

Sweetener compositions comprising particular glycoside compositions are described herein. The glycoside compositions comprise rebaudioside A, rebaudioside B, rebaudioside D, and rebaudioside M in various proportions. The sweetener compositions can also include one or more bulking agents or other ingredients. The sweetener compositions can be used in foods and beverages.

### CROSS REFERENCES TO RELATED APPLICATION

This application claims the benefit of U.S. Provisional Patent Application No. 62/083,651, filed Nov. 24, 2014, entitled GLYCOSIDE COMPOSITIONS, which is hereby incorporated by reference in its entirety.

### FIELD OF THE DISCLOSURE

The present disclosure relates to sweetener compositions comprising glycoside compositions. The sweetener compositions of the present disclosure can further comprise other ingredients, such as one or more bulking agents. The present disclosure also relates to incorporation of the sweetener compositions into foods and/or beverages.

### SUMMARY

The present disclosure relates to sweetener compositions comprising particular glycoside compositions. The sweetener compositions of the present disclosure can also include other ingredients such as bulking agents, flavorings, other high intensity sweeteners, or the like. The present disclosure also pertains to the use of the sweetener compositions in foods and beverages.

Certain mixtures of particular glycosides at certain ratios result in compositions that have higher effective sweetening power than rebaudioside D or rebaudioside M alone. Additionally, some compositions have lower bitterness (while attaining the same or higher sweetness) than rebaudioside D or rebaudioside M alone. Some compositions have faster sweetness onset and/or less linger than rebaudioside D or rebaudioside M alone. Yet other compositions may have a taste, which is more pleasing than rebaudioside D or rebaudioside M alone. These mixtures of glycosides include, for example, rebaudioside A, rebaudioside B, rebaudioside D, and rebaudioside M.

The term “glycoside composition” as used herein means a composition of the various glycosides obtained from the stevia plant. These glycosides include, but are not limited to, rebaudioside A-F, M, stevioside dulcoside, steviobioside, and rubusoside. In particular, the glycoside compositions of the present disclosure include compositions consisting predominantly of any or all of rebaudioside A, rebaudioside B, rebaudioside D, and rebaudioside M.

The terms “rebaudioside-ABDM”, “Reb-ABDM”, and variations thereof, as used herein, refers to a glycoside composition in which the primary components of the glycoside composition are rebaudioside A, rebaudioside B, rebaudioside D and rebaudioside M (hence, the “ABDM”). Other glycoside compositions may likewise be referred to in a similar manner. In a rebaudioside-ABDM composition, the combination of rebaudioside A, rebaudioside; B, rebaudioside D, and rebaudioside M will make up at least 85%, at least 90%, at least 95%, at least 97%, or at least 99% of the total glycosides in the rebaudioside-ABDM composition.

Higher effective sweetening power can mean that a certain SEV can be achieved by a particular rebaudioside-ABDM composition at a lower concentration than rebaudioside D or rebaudioside M alone. Alternately, higher effective sweetening power can mean that a composition has greater potency than rebaudioside D or rebaudioside M alone, that is, at equivalent concentrations, the composition shows a higher SEV than rebaudioside D or rebaudioside M alone. Higher effective sweetening power may also mean that a particular composition has a faster sweetness onset than rebaudioside D or rebaudioside M alone. A composition having higher effective sweetening power may be described herein as having higher sweetness, increased sweetness, or the like when compared to rebaudioside D or rebaudioside M alone.

In some embodiments, the glycoside compositions provide a relatively high SEV in the sweetener compositions. In these embodiments, when a higher level of sweetness is needed in sweetener compositions for certain food or beverage applications, the substantial benefit that the glycoside compositions provide could better be realized,

In one particular embodiment, a composition comprising 1% to 15% rebaudioside A, 4% to 15% rebaudioside B, 3% to 45% rebaudioside D, and 25% to 81% rebaudioside M, is provided. This composition may be sweeter than rebaudioside D or rebaudioside M alone. Additionally, or alternatively, this composition may have a faster sweetness onset and/or less linger than rebaudioside D or rebaudioside M alone.

In another particular embodiment, a composition comprising 1% to 18% rebaudioside A, 4% to 18% rebaudioside B, 8% to 37% rebaudioside D, and 43% to 75% rebaudioside M is provided. This composition may be less bitter than rebaudioside D or rebaudioside M alone. Additionally, or alternatively, this composition may have a shorter bitter aftertaste than rebaudioside D or rebaudioside M alone.

In an embodiment, the pH of the food or beverage incorporating the rebaudioside-ABDM composition may be in a range of about 2-7. In other embodiments, the pH of the food or beverage may be less than 6, less than 5, less than 4, less than 3, less than 2.5, or less than 2.

In sonic embodiments, the rebaudioside-ABDM composition of this disclosure provides an SEV of greater than 5, greater than 6, greater than 7, greater than 7.2, greater than 7.5, greater than 7.8, greater than 8, greater than 8.3, greater than 9, or greater than 10.

In another embodiment, sweetener compositions made with rebaudioside-ABDM compositions of this disclosure are provided. The sweetener compositions comprise any rebaudioside-ABDM composition of this disclosure and a bulking agent, in other embodiments; the rebaudioside-ABDM compositions of the present invention can be utilized as flavor modifiers.

These and other objects, features, and advantages of the invention will be apparent from the following detailed description and claims.

### DETAILED DESCRIPTION

Applicants have surprisingly discovered that certain compositions made up predominantly of rebaudioside A, rebaudioside B, rebaudioside D, and rebaudioside M result in compositions (Reb-ABDM compositions) which have higher effective sweetening ability than the pure components rebaudioside D or rebaudioside M. That is, the same level of sweetness can be achieved with a lower concentration of the Reb-ABDM composition than the amount that would be needed with the pure components rebaudioside D or rebaudioside M. The reduction in concentration of glycoside needed to achieve a certain level of sweetness can result in ample savings by allowing the utilization of lower amounts of the glycoside in sweetener compositions yet achieving the same level of sweetness. Additionally, lower levels of glycoside could allow for easier incorporation into certain foods and beverages. In sonic embodiments, the added benefit of reduced bitterness (while attaining the same sweetness) is also achieved. These benefits are particularly surprising given that rebaudioside D and rebaudioside M are thought to be particularly sweet glycosides with low levels of bitterness.

Additionally, or alternatively, the compositions of this disclosure provide increased sweetness compared to rebaudioside D or rebaudioside M alone, having a high level of purity (i.e. at least 60% pure, in some embodiments at least 80% pure, in other embodiments at least 90% pure, in yet other embodiments, at least 95% pure). Additionally, or alternatively, certain compositions of this disclosure provide decreased bitterness compared to rebaudioside D or rebaudioside M alone. Additionally, or alternatively, certain compositions of this disclosure provide an onset of sweetness (to the taster) that is faster than rebaudioside D or rebaudioside M alone. Additionally, or alternatively, certain compositions of this disclosure provide decreased licorice taste compared to rebaudioside D or rebaudioside M alone. Additionally, or alternatively, certain compositions of this disclosure provide less linger than rebaudioside D or rebaudioside M alone. Additionally, or alternatively, certain compositions of this disclosure provide a more sucrose-like taste than rebaudioside D or rebaudioside M alone. Additionally, or alternatively, certain compositions of this disclosure provide a more pleasing taste than rebaudioside D or rebaudioside M alone. The certain glycoside compositions described herein may show these or other taste benefits when compared to rebaudioside D or rebaudioside M alone particularly, or compared to other glycosides compositions.

The chemical structures of rebaudioside A, rebaudioside B, rebaudioside D, rebaudioside M are well known in the art. The chemical structure of these compounds is also found in patent applications WO2012/082677 and WO2014/052457, which are both incorporated by reference.

The compositions, in addition to rebaudioside A, rebaudioside B, rebaudioside D, and/or rebaudioside M optionally include one or more other glycosides from the stevia plant, such as rebaudioside C (dulcoside B), rebaudioside E, rebaudioside F, dulcoside A and rubusoside. The compositions include no more than 15% of these optional glycosides. In some embodiments, the compositions typically include no more than about 10% of these other glycosides. In other embodiments, the compositions typically include no more than about 5% of these other glycosides and in yet other embodiments, no more than about 3%, 2%, or 1% of glycosides other than rebaudioside A, rebaudioside B, rebaudioside D, and rebaudioside M.

Specific examples of compositions that have an unexpectedly high level of sweetness and a low level of bitterness are provided in Table 1 and Table 2.

TABLE 1

| Total | |
|---|---|
| Composition | Composition Percentage |

| (ppm) | A | B | D | M |
|---|---|---|---|---|
| 300-500 | 5 to 15 | 5 to 15 | 20 to 30 | 50 to 60 |
| 300-500 | 5 to 15 | 5 to 15 | 13 to 23 | 57 to 67 |
| 300-500 | 5 to 15 | 5 to 15 | 35 to 45 | 35 to 45 |
| 300-500 | 3 to 13 | 3 to 13 | 3 to 13 | 71 to 81 |
| 300-500 | 1 to 10 | 5 to 15 | 25 to 35 | 25 to 35 |

TABLE 2

| Total | |
|---|---|
| Composition | Composition Percentage |

| (ppm) | A | B | D | M |
|---|---|---|---|---|
| 500-700 | 8 to 18 | 8 to 18 | 8 to 18 | 56 to 66 |
| 500-700 | 5 to 15 | 5 to 15 | 27 to 37 | 43 to 53 |
| 500-700 | 5 to 15 | 5 to 15 | 20 to 30 | 50 to 60 |
| 500-700 | 1 to 10 | 4 to 10 | 15 to 25 | 65 o 75 |

In some embodiments, these compositions can provide a sweetener composition having a particularly high SEV level. In some other embodiments, these compositions provide an SEV of greater than 5 when present in a sweetener composition, in still other embodiments these compositions provide an SEV of greater than 6 when present in a sweetener composition, in still other embodiments these compositions provide an SENT of greater than 7 when present in a sweetener composition, in still other embodiments these compositions provide an SEV of greater than 8 when present in a sweetener composition, in still other embodiments these compositions provide an SEV of greater than 9 when present in a sweetener composition, and in still other embodiments these compositions provide an SEV of greater than 10 when present in a sweetener composition.

Broadly, a rebaudioside-ABDM composition comprises, by weight, at least 1% yet no more than 15% rebaudioside A. at least 4% vet no more than 20% rebaudioside B, at least 3% yet no more than 45% rebaudioside D, and at least 35% yet no more than 81% rebaudioside M (based on the amount of rebaudioside A, rebaudioside B, rebaudioside D and rebaudioside M in the composition).

Some preferred rebaudioside-ABDM compositions comprise, by weight, at least 1% yet no more than 15% rebaudioside A, at least 4% yet no more than 20% rebaudioside B, at least 3% yet no more than 45% rebaudioside D, and at least 35% yet no more than 81% rebaudioside M (based on the amount of rebaudioside A, rebaudioside B, rebaudioside D and rebaudioside M in the composition).

Other preferred rebaudioside-ABDM compositions comprise, by weight, at least 1% yet no more than 18% rebaudioside A, at least 4% yet no more than 18% rebaudioside B, at least 8% yet no more than 37% rebaudioside D, and at least 43% yet no more than 75% rebaudioside M (based on the amount of rebaudioside A, rebaudioside B, rebaudioside D and rebaudioside M in the composition).

Other examples of Reb-ABDM compositions are provided in Tables 3-9.

TABLE 3
Composition Percentage

| Reb A | Reb B | Reb D | Reb M |
|---|---|---|---|
| 2 to 20 | 4 to 20 | 5 to 50 | 30 to 85 |
| 5 to 13 | 5 to 15 | 8 to 40 | 40 to 76 |

The Reb-ABDM compositions provided in Tables 4-6 showed particular benefits when provided at certain concentrations, for example, from 450 ppm to 1000 ppm, from 450 ppm to 850 ppm, from 500 ppm to 800 ppm, from 500 ppm to 700 ppm, from 550 ppm to 650 ppm, from 575 ppm to 625 ppm, or about 600 ppm.

TABLE 4
Composition Percentage

| Reb A | Reb B | Reb D | Reb M |
|---|---|---|---|
| 2 to 20 | 4 to 20 | 2 to 50 | 35 to 85 |
| 5 to 10 | 8 to 15 | 8 to 40 | 40 to 76 |

TABLE 5
Composition Percentage

| Reb A | Reb B | Reb D | Reb M |
|---|---|---|---|
| 2-15 | 5-20 | 25-45 | 35 to 55 |
| 5-10 | 10-15 | 30-40 | 35 to 55 |
| 2-15 | 5-20 | 25-45 | 40 to 50 |
| 5-10 | 10-15 | 30-40 | 40 to 50 |
| 2-15 | 5-20 | 20-35 | 45 to 60 |
| 5-10 | 10-15 | 25-30 | 45 to 60 |
| 2-15 | 5-20 | 20-35 | 50 to 55 |
| 5-10 | 10-15 | 25-30 | 50 to 55 |
| 5-15 | 5-15 | 10-30 | 50 to 65 |
| 8-12 | 8-12 | 18-25 | 50 to 65 |
| 5-15 | 5-15 | 10-30 | 55 to 62 |
| 8-12 | 8-12 | 18-25 | 55 to 62 |
| 5-15 | 5-15 | 5-25 | 60 to 80 |
| 7-12 | 7-12 | 8-18 | 60 to 80 |
| 5-15 | 5-15 | 5-25 | 62 to 76 |
| 7-12 | 7-12 | 8-18 | 62 to 76 |

TABLE 6
Composition Percentage

| Reb A | Reb B | Reb D | Reb M |
|---|---|---|---|
| 5-15 | 5-15 | 35-45 | 35 to 45 |
| 8-12 | 8-12 | 38-42 | 38 to 42 |
| about 10 | about 10 | about 40 | about 40 |
| 2-15 | 10-20 | 25-35 | 45 to 55 |
| 2-8 | 12-17 | 28-32 | 48 to 52 |
| about 5 | about 15 | about 30 | about 50 |
| 5-15 | 5-15 | 20-30 | 50 to 60 |
| 8-12 | 8-12 | 22-28 | 53 to 57 |
| about 10 | about 10 | about 25 | about 55 |
| 5-15 | 5-15 | 10-25 | 57 to 67 |
| 8-12 | 8-12 | 15-22 | 60 to 64 |
| about 10 | about 10 | about 18 | about 62 |
| 2-15 | 2-15 | 2-15 | 71 to 81 |
| 5-10 | 5-10 | 5-10 | 74 to 78 |
| about 8 | about 8 | about 8 | about 76 |

In an embodiment, a composition comprising 300-500 ppm may include 2-15%, 5-10%, 8-12%, 5-15%, 7-12% rebaudioside A; 5-20%, 10-15%, 5-15%, 8-12%, 7-12% rebaudioside B; 25-45%, 30-40%, 20-35%, 10-30%, 18-25%, 5-25%, 8-18% rebaudioside D; .and 35-55%, 40-50%, 45-60%, 50-55%, 50-65%, 55-62%, 60-80%, 62-76% rebaudioside M. In another example embodiment, a composition comprising 300-500 ppm may include 2-8% rebaudioside A; 10-20%, 12-17%, 2-15%, 5-10% rebaudioside B; 35-45%, 38-42%, 25-35%, 28-32%, 20-30%, 22-28%, 10-25%, 15-22%, 2-15%, 5-10% rebaudioside D; and 35-45%, 38-42%, 45-55%, 48-52%, 50-60%, 53-57%, 57-67%, 60-64%, 71-81%, 74-78% rebaudioside M.

The Reb-ABDM compositions provided in Tables 7-9 showed particular benefits when provided at certain concentrations, for example, from 250 ppm to 550 ppm, from 300 ppm to 500 ppm, from 350 ppm to 450 ppm, from 375 ppm to 425 ppm, or about 400 ppm.

TABLE 7
Composition Percentage

| Reb A | Reb B | Reb D | Reb M |
|---|---|---|---|
| 2 to 20 | 4 to 20 | 8 to 40 | 40 to 80 |
| 5 to 13 | 5 to 13 | 13 to 32 | 48 to 70 |

TABLE 8
Composition Percentage

| Reb A | Reb B | Reb D | Reb M |
|---|---|---|---|
| 5-15 | 5-15 | 20-35 | 45 to 60 |
| 8-12 | 8-12 | 25-32 | 45 to 60 |
| 5-15 | 5-15 | 20-35 | 48 to 55 |
| 8-12 | 8-12 | 25-32 | 48 to 55 |
| 8-15 | 8-15 | 10-30 | 50 to 65 |
| 10-13 | 10-13 | 13-25 | 50 to 65 |
| 8-15 | 8-15 | 10-30 | 55 to 61 |
| 10-13 | 10-13 | 13-25 | 55 to 61 |
| 2-15 | 4-15 | 10-25 | 57 to 75 |
| 5-13 | 5-13 | 13-20 | 57 to 75 |
| 2-15 | 4-15 | 10-25 | 61 to 70 |
| 5-13 | 5-13 | 13-20 | 61 to 70 |

TABLE 9
Composition Percentage

| Reb A | Reb B | Reb D | Reb M |
|---|---|---|---|
| 5-15 | 5-15 | 27-37 | 43 to 53 |
| 8-12 | 8-12 | 30-34 | 46-50 |
| about 10 | about 10 | about 32 | about 48 |
| 5-15 | 5-15 | 20-30 | 50-60 |
| 8-12 | 8-12 | 23-27 | 53-57 |
| about 10 | about 10 | about 25 | about 55 |
| 8-18 | 8-18 | 8-18 | 56 to 66 |
| 11-15 | 11-15 | 11-15 | 59 to 63 |
| about 13 | about 13 | about 13 | about 61 |
| 2-10 | 4-10 | 15-25 | 65 to 75 |
| 3-7 | 4-7 | 18-22 | 68 to 72 |
| about 5 | about 5 | about 20 | about 70 |

In yet another embodiment, a composition comprising 500-700 ppm may include 5-15%, 8-12%, 10-13%, 8-15%, 2-15%, 5-13% rebaudioside A; 5-15%, 8-12%, 10-13%, 8-15%, 4-15%, 5-13% rebaudioside B; 20-35%, 25-32%, 10-30%, 13-25%, 10-25%, 13-20% rebaudioside D; and 45-60%, 48-55%, 50-65%, 55-61%, 57-75%, 61-70% rebaudioside M. In still yet another embodiment, a composition comprising 500-700 ppm may include 8-18%, 11-15%, 2-10%, 3-7% rebaudioside A; 8-18%, 11-15%, 4-10%, 4-7% rebaudioside B; 27-37%, 30-34%, 20-30%, 23-27%, 8-18%, 11-15%, 15-25%, 8-22% rebaudioside D; and 43-53%, 46-50%, 50-60%, 53-57%, 56-66%, 59-63%, 65-75%, 68-72% rebaudioside M.

Yet other examples of compositions that have an unexpectedly high level of sweetness and a low level of bitterness are provided in Table 10 and Table 11.

TABLE 10

| Total | |
|---|---|
| Composition | Composition Percentage |

| (ppm) | Reb A | Reb B | Reb D | Reb M |
|---|---|---|---|---|
| 300-500 | 5 to 15 | 5 to 15 | 20 to 30 | 50 to 60 |
| 300-500 | 5 to 15 | 5 to 15 | 13 to 23 | 57 to 67 |
| 300-500 | 5 to 15 | 5 to 15 | 35 to 45 | 35 to 45 |
| 300-500 | 3 to 13 | 4 to 13 | 3 to 13 | 71 to 81 |
| 300-500 | 1 to 10 | 10 to 20 | 25 to 35 | 45 to 55 |

TABLE 11

| Total | |
|---|---|
| Composition | Composition Percentage |

| (ppm) | Reb A | Reb B | Reb D | Reb M |
|---|---|---|---|---|
| 500-700 | 8 to 18 | 8 to 18 | 8 to 18 | 56 to 66 |
| 500-700 | 5 to 15 | 5 to 15 | 27 to 37 | 43 to 53 |
| 500-700 | 5 to 15 | 5 to 15 | 20 to 30 | 50 to 60 |
| 500-700 | 1 to 10 | 4 to 10 | 15 to 25 | 65 o 75 |

In an embodiment, a composition may comprise from about 50-60%, or from about 57-67% rebaudioside M. Another embodiment, a composition may comprise from about 35-45% or from about 71-81% rebaudioside M. Yet another embodiment, a composition may comprise from about 45-55% rebaudioside M.

In another embodiment, a composition may comprise from about 56-66% or from about 43-53% rebaudioside M. In another embodiment, a composition may comprise 50-60% or from about 65-75% rebaudioside M.

Yet other embodiments can be described according to the amounts of Reb D and Reb M in the Reb-ABDM composition and the relative percentage of Reb D and Reb M in the Reb-ABDM composition. In some of these embodiments, the combination of Reb D and Reb M makes up at least 60% of the Reb-ABDM composition, in other embodiments at least 70% of the Reb-ABDM composition, in yet other embodiments at least 74% of the Reb-ABDM composition, in yet other embodiments at least 80% of the Reb ABDM composition, in yet other embodiments at least 84% of the Reb-ABDM composition, in yet other embodiments at least 90% of the Reb-ABDM composition. In other embodiments, the combination of Reb D and Reb M comprises 74% to 90% of the Reb-ABDM composition. In yet other embodiments, the combination of Reb D and Reb M comprises 80% to 90% of the Reb-ABDM composition. In yet other embodiments, the combination of Reb D and Reb M comprises 84% to 90% of the Reb-ABDM composition. In yet other embodiments, the combination of Reb D and Reb M comprises 80% to 84% of the Reb-ABDM composition.

In some of these embodiments, the Reb-ABDM composition comprises from 10% to 50% Reb D and from 50% to 90% Reb M (of the total Reb D and Reb M in the Reb-ABDM composition). In other embodiments, the Reb-ABDM composition comprises from 31% to 50% Reb D and from 50% to 69% Reb M (of the total Reb D and Reb M in the Reb-ABDM composition). In yet other embodiments, the Reb-AI3DM composition comprises from 38% to 50% Reb D and from 50% to 63% Reb M (of the total Reb D and Reb M in the Reb-ABDM composition). In yet other embodiments, the Reb-ABDM composition comprises from 40% to 50% Reb D and from 50% to 60% Reb M (of the total Reb D and Reb M in the Reb-ABDM composition). In yet other embodiments, the Reb-ABDM composition comprises from 38% to 40% Reb D and from 60% to 63% Reb M (of the total R.eb D and Reb M in the Reb-ABDM composition).

In yet other embodiments, the Reb-ABDM composition comprises from 18% to 40% Reb D and from 60% to 82% Reb M (of the total Reb D and Reb M in the Reb-ABDM composition). In yet other embodiments, the Reb-ABDM composition comprises from 22% to 40% Reb D and from 60% to 78% Reb M (of the total Reb D and Reb M in the Reb-ABDM composition). In yet other embodiments, the Reb-ABDM composition comprises from 22% to 38% Reb D and from 63% to 78% Reb M (of the total Reb D and Reb M in the Reb-ABDM composition). In yet other embodiments, the Reb-ABDM composition comprises from 22% to 31% Reb D and from 69% to 78% Reb M (of the total Reb D and Reb M in the Reb-ABDM composition).

In yet other embodiments, the Reb-ABDM composition comprises from 10% to 22% Reb D and from 78% to 90% Reb M (of the total Reb D and Reb M in the Reb-ABDM composition). In yet other embodiments, the Reb-ABDM composition comprises from 10% to 18% Reb D and from 82% to 90% Reb M (of the total Reb D and R.eb M in the Reb-ABDM composition). In yet other embodiments, the Reb-ABDM composition comprises from 22% to 38% Reb D and from 63% to 78% Reb M (of the total Reb D and Reb M in the Reb-ABDM composition).

The embodiments of the Reb-ABDM compositions described according to the amounts of Reb D and Reb Min the Reb-ABDM composition and the relative percentage of Reb D and Reb M in the Reb-ABDM composition can also include Reb A and Reb B.

Sweetener Compositions with Glycoside Compositions

As indicated above, the certain compositions of rebaudioside M combined with rebaudioside A, rebaudioside B and/or rebaudioside D result in compositions having a have higher sweetening ability than rebaudioside D alone or rebaudioside M alone Thus, the utilization of these compositions in a sweetener composition could result in significant cost savings.

The sweetener compositions can also include other ingredients in addition to the glycoside composition. In some embodiments, the sweetener composition can include one or more of bulking agent(s), a high-intensity sweetener(s), flavoring(s), an antioxidant, caffeine, other nutritive sweetener(s) salt(s), protein, bitter blocker, or a sweetness enhancer.

A bulking agent can include any compositions known in the art used to add bulk to high intensity sweeteners. Bulking agents are often used with high intensity sweeteners, such as the glycoside compositions of this disclosure, to facilitate a direct substitution of sweeteners of this disclosure f.or other sweeteners, such as sugar, in applications such as baking, cooking, and tabletop uses. A bulking agent may be chosen from a bulk sweetener, a lower glycemic carbohydrate, a fiber, a hydrocolloid, and combinations thereof. A bulk sweetener may be chosen from corn sweeteners, sucrose, dextrose, invert sugar, maltose, dextrin, maltodextrin, fructose, levulose, high fructose corn syrup, corn syrup solids, galactose, trehalose, isomaltulose, fructo-oligosaccharides, and combinations thereof. A lower glycemic carbohydrate may be chosen from fructo-oligosaccharide, galactooligosaccharide, isomaltooligosaccharide, oligodextran, D-tagatose, sorbitol, mannitol, xylitol, lactitol, erythritol, maltitol, other polyols, hydrogenated starch hydrolysates, isottialt, D-psicose, 1,5 anhydro D-fructose, and combinations thereof.

A fiber may be chosen from polydextrose, resistant maltodextrin, resistant starch, inulin, soluble corn fiber, beta-glucan, psyllium, cellulose, hemicellulose, and combinations thereof. A hydrocolloid may be chosen from pectin (e.g., apple, beet, citrus), gum Arabic, guar gum, carboxymethylcellulose, nOSA (n-octenyl succinic anhydride), locust bean gum, cassia gum, xanthan gum, carrageenan, alginate, and combinations thereof.

A high intensity sweetener may be chosen from sucralose, aspartame, saccharin, acesulfame K, alitame, thaumatin., dihydrochalcones, neotame, cyclamates, mogroside, glycyrrhizin, phyllodulcin, monellin, mahinlin, brazzein, circulin, pentadin, monatin, and combinations thereof. A flavoring may be chosen from a cola flavor, a citrus flavor, a root beer flavor, and combinations thereof. A sweetness enhancer may be chosen from curculin, miraculin, cynarin, chlorogenic acid, caffeic acid, strogins, arabinogalactan, maltol, dihyroxybenzoic acids, and combinations thereof.

Other ingredients such as food starch, flours, protein isolates, protein concentrates, food fats and oils (such as cocoa butter), emulsifiers, food extracts (such as malt extract), and juice concentrates may also be included in the sweetener compositions.

In some particular embodiments, the sweetener composition can also include a lower glycemic carbohydrate. In certain embodiments, the lower glycemic carbohydrate is erythritol or another polyol.

### Food and Beverage Compositions

The glycoside compositions and/or sweetener compositions of the present disclosure can be incorporated into food and beverage compositions. Thus, the present disclosure also contemplates food compositions and beverage compositions that include the glycoside compositions and/or sweetener compositions of the present disclosure.

Examples of food compositions include baked goods, soups, sauces, processed meats canned fruits, canned vegetables, dairy products, frozen confections, confections, chewing gums, cakes, cookies, bars, and other sweet bakery items, cereals, cereal bars, yogurt, energy bars, granola bars, hard candy, jelly candy, chocolate candy, and other sweet confections. Examples of beverages include carbonated soft drinks, powdered soft drinks, ready to drink teas, sports drinks, dairy drinks, yogurt-containing drinks, alcoholic beverages, energy drinks, flavored waters, vitamin drinks, fruit drinks, and fruit juices.

Examples of other edible compositions into which the sweetener compositions of this disclosure can be used include oral care products such as toothpastes, mouthwashes, and oral rinses; pharmaceutical products such as tablets, capsules, lozenges, and suspensions; and nutraceutical products such as supplements, vitamins, probiotics and probiotics.

Non-edible products, but those that may be considered as food products, to which the sweetener compositions of this disclosure can be added include tobacco products such as pipe tobacco, snuff and chewing tobacco.

### Methods of Producing Compositions and Sweetener Compositions

The present disclosure also contemplates methods for producing the glycoside compositions and the sweetener compositions. Typical conventional stevia based sweeteners include a glycoside composition which consists primarily of rebaudioside A (for.example greater than 80% rebaudioside A, greater than 95% rebaudioside A, or greater than 97% rebaudioside A). The present disclosure contemplates adding rebaudioside B, rebaudioside D, and rebaudioside M to such conventional sweeteners. In some embodiments, any of rebaudioside B, rebaudioside D and rebaudioside M could be added to such sweeteners to achieve the desired glycoside composition ratios.

The present disclosure also contemplates controlled conversion between one glycoside and another glycoside to achieve the glycoside compositions of the present disclosure. Thus, in one embodiment, a composition comprising one or more glycosides can be converted to particular rebaudioside-ABDM compositions at the disclosed ratios.

### EXAMPLES

A 20 person sensory panel was trained to scale sweetness and bitterness. Reference tasting standards were prepared by dissolving respective standard material (sucrose for sweetness and caffeine for bitterness) into a citric acid base at pH 3.1 (distilled water containing 0.1% citric acid and 0.015% sodium citrate) according to the scale values shown in Table 12 below.

TABLE 12
Reference Tasting Standards

Concentration (g/kg)

| | Sucrose | Caffeine |
|---|---|---|
| Scale | (Sweetness) | (Bitterness) |
| 1 | 10 | 0.107 |
| 2 | 20 | 0.153 |
| 3 | 30 | 0.200 |
| 4 | 40 | 0.246 |
| 5 | 50 | 0.293 |
| 6 | 60 | 0.340 |
| 7 | 70 | 0.386 |
| 8 | 80 | 0.433 |
| 9 | 90 | 0.479 |
| 10 | 100 | 0.526 |
| 11 | 110 | 0.572 |
| 12 | 120 | 0.619 |
| 13 | 130 | 0.666 |
| 14 | 140 | 0.712 |
| 15 | 150 | 0.759 |

Pure rebaudioside A, rebaudioside B, rebaudioside D, and rebaudioside M were used in this example.

The trained sensory panel evaluated composition solutions of rebaudioside A, rebaudioside B, rebaudioside D, and rebaudioside M at ratios and concentrations shown in Tables 13 and 14. Solutions were made in the same citric acid base as the training solutions. All solutions were heated to 55° C. for 12 minutes to ensure that all the glycoside material was completely dissolved. The solutions were allowed to cool to room temperature before serving to the panelists. Each solution was given a random 3-digit code and was served to the panelists in random order. Panelists dispensed 2 mL of each solution into their mouths from a pipette. The panelists were then asked to rate the “sweetness intensity” and “bitterness intensity” of the solutions and mark their responses on an un-anchored, 1.5 cm line scale. The data was collected and compiled using EyeQuestion sensory software (Logic8).

Control samples of commercial rebaudioside A (Cargill, Incorporated) between 200-700 ppm were used throughout the testing to monitor panelist consistency. In between testing samples, the panelists cleansed their palates with water and apple slices. The panelists also waited 5 minutes between each sample. The panelists' responses were measured, compiled, and averaged for each sample. One data point was removed from consideration for this example (400 ppm total concentration at 13% rebaudioside A, 13% rebaudioside B, 61% rebaudioside D, and 13% rebaudioside M) as the sensory data suggested it was an unintentional duplication of the 600 ppm sample of the same composition.

Sweet and bitter responses of pure rebaudioside D and pure rebaudioside M at varying concentrations were also obtained utilizing a sensory panel in a manner as described above.

Tables 13 and 14 show the concentration of the composition tested (ppm) as well as the ratio of one glycoside to another in the composition as a percentage. Each composition's sweetness and bitterness was measured by the trained panel. The composition's sweetness was measured as SEV (sucrose equivalent value).

Each composition was then compared to an isosweet concentration of pure rebaudioside D and pure rebaudioside M. This value represents the concentration of pure rebaudioside D or pure rebaudioside M needed to achieve the SEV measured for the composition. Thus, if the value is greater than that of the composition, then a larger concentration of pure rebaudioside D or pure rebaudioside M would be needed to achieve the same sweetness as achieved by the composition (at the lower dosage).

Tables 13 and 14 also include an isosweet bitterness for pure rebaudioside D and pure rebaudioside M. This value represents the intensity of bitterness measured for that concentration of pure rebaudioside D or pure rebaudioside M.

The concentration of the isosweet solution of rebaudioside D and rebaudioside and the bitterness of the isosweet solutions were calculated by a fit of the pure component sensory response to standard psycho-sensory models.

As seen in tables 13 and 14, certain Reb-ABDM compositions showed an unexpected higher sweetening ability than pure rebaudioside D or pure rebaudioside M. Additionally, many of these compositions showed an additional benefit in less bitterness at the same SEV level. Thus, not only could less total glycoside be used to achieve the same SEV level (compared to pure rebaudioside D or pure rebaudioside M), the Reb-ABDM compositions would also be less bitter than either pure rebaudioside D or pure rebaudioside M. This is quite surprising since rebaudioside D and rebaudioside M are considered to be sweeter and less bitter than many other glycosides, including rebaudioside A and rebaudioside B. These particularly beneficial Reb-ABDM compositions are described throughout this application, but particularly in Tables 1-11.

TABLE 13

| | | | | | | | IsoSweet Pure Fraction | | | |
|---|---|---|---|---|---|---|---|---|---|---|
| | | | | | | | Concentrations | | | |
| Total | | | | | Blend Sensory | | Reb D | | Reb M | |
| Blend | Blend Percentage (%) | | | | Averages | | Sweet | | Sweet | |
| (ppm) | Reb A | Reb B | Reb D | Reb M | Sweet | Bitter | (ppm) | Bitter | (ppm) | Bitter |
| 600 | 13 | 13 | 13 | 61 | 8.6 | 4.0 | 807 | 4.7 | 661 | 4.5 |
| 600 | 10 | 10 | 32 | 48 | 8.6 | 4.1 | 804 | 4.7 | 658 | 4.5 |
| 600 | 10 | 10 | 25 | 55 | 8.6 | 4.1 | 771 | 4.7 | 632 | 4.5 |
| 600 | 5 | 5 | 20 | 70 | 8.5 | 3.7 | 739 | 4.7 | 606 | 4.4 |
| 600 | 10 | 20 | 35 | 35 | 8.4 | 3.8 | 702 | 4.6 | 577 | 4.4 |
| 600 | 10 | 10 | 18 | 62 | 8.4 | 4.0 | 686 | 4.6 | 564 | 4.3 |
| 600 | 8 | 8 | 8 | 76 | 8.2 | 3.9 | 647 | 4.6 | 532 | 4.2 |
| 648 | 25 | 25 | 25 | 25 | 8.2 | 4.0 | 630 | 4.5 | 519 | 4.2 |
| 600 | 20 | 10 | 35 | 35 | 8.1 | 4.1 | 603 | 4.5 | 497 | 4.1 |
| 600 | 25 | 25 | 25 | 25 | 8.1 | 4.1 | 600 | 4.5 | 494 | 4.1 |
| 600 | 8 | 8 | 76 | 8 | 8.1 | 3.9 | 598 | 4.5 | 493 | 4.1 |
| 600 | 5 | 5 | 36 | 54 | 8.0 | 3.7 | 582 | 4.4 | 480 | 4.1 |
| 600 | 10 | 10 | 40 | 40 | 7.9 | 3.8 | 558 | 4.4 | 460 | 4.0 |
| 600 | 5 | 15 | 30 | 50 | 7.9 | 3.9 | 555 | 4.4 | 458 | 4.0 |
| 600 | 13 | 13 | 61 | 13 | 7.8 | 3.9 | 530 | 4.3 | 437 | 3.9 |
| 600 | 53 | 11 | 16 | 20 | 7.6 | 3.8 | 497 | 4.2 | 411 | 3.8 |
| 649 | 50 | 17 | 17 | 17 | 7.5 | 3.6 | 477 | 4.1 | 395 | 3.7 |
| 650 | 75 | 8 | 8 | 8 | 7.5 | 3.9 | 476 | 4.1 | 394 | 3.7 |
| 600 | 5 | 5 | 28 | 62 | 7.4 | 3.7 | 468 | 4.1 | 387 | 3.7 |
| 551 | 30 | 9 | 30 | 30 | 7.3 | 3.7 | 451 | 4.0 | 374 | 3.6 |

TABLE 14

| | | | | | | | IsoSweet Pure Fraction | | | |
|---|---|---|---|---|---|---|---|---|---|---|
| | | | | | | | Concentrations | | | |
| Total | | | | | Blend Sensory | | Reb D | | Reb M | |
| Blend | Blend Percentage (%) | | | | Averages | | Sweet | | Sweet | |
| (ppm) | Reb A | Reb B | Reb D | Reb M | Sweet | Bitter | (ppm) | Bitter | (ppm) | Bitter |
| 400 | 10 | 10 | 25 | 55 | 8.2 | 3.7 | 629 | 4.5 | 517 | 4.2 |
| 400 | 10 | 10 | 18 | 62 | 7.7 | 3.7 | 516 | 4.2 | 426 | 3.9 |
| 400 | 10 | 10 | 40 | 40 | 7.7 | 3.7 | 515 | 4.2 | 425 | 3.9 |
| 400 | 8 | 8 | 8 | 76 | 7.6 | 3.8 | 503 | 4.2 | 415 | 3.8 |
| 500 | 47 | 22 | 19 | 12 | 7.6 | 3.9 | 497 | 4.2 | 411 | 3.8 |
| 400 | 5 | 15 | 30 | 50 | 7.6 | 3.6 | 497 | 4.2 | 411 | 3.8 |
| 400 | 13 | 13 | 13 | 61 | 7.4 | 3.6 | 466 | 4.1 | 386 | 3.7 |
| 500 | 25 | 25 | 25 | 25 | 7.4 | 3.6 | 456 | 4.0 | 377 | 3.7 |
| 400 | 8 | 8 | 76 | 8 | 7.3 | 3.6 | 440 | 4.0 | 364 | 3.6 |
| 400 | 5 | 5 | 20 | 70 | 7.3 | 3.5 | 440 | 4.0 | 364 | 3.6 |
| 400 | 10 | 10 | 32 | 48 | 7.3 | 3.5 | 439 | 4.0 | 364 | 3.6 |
| 400 | 5 | 5 | 28 | 62 | 7.2 | 3.7 | 435 | 3.9 | 361 | 3.6 |
| 400 | 10 | 20 | 35 | 35 | 7.2 | 3.5 | 429 | 3.9 | 356 | 3.6 |
| 500 | 47 | 31 | 13 | 9 | 7.2 | 4.1 | 426 | 3.9 | 354 | 3.5 |
| 400 | 20 | 10 | 35 | 35 | 7.1 | 3.4 | 414 | 3.8 | 344 | 3.5 |
| 499 | 50 | 17 | 17 | 17 | 7.0 | 3.5 | 412 | 3.8 | 341 | 3.5 |
| 399 | 5 | 5 | 36 | 54 | 7.0 | 3.5 | 412 | 3.8 | 341 | 3.5 |
| 501 | 75 | 8 | 8 | 8 | 7.0 | 3.6 | 406 | 3.8 | 337 | 3.5 |
| 500 | 53 | 11 | 16 | 20 | 6.9 | 3.3 | 396 | 3.8 | 329 | 3.4 |

1. A sweetener composition comprising from about 1 to 15% rebaudioside A, about 4 to 20% rebaudioside B, about 3 to 45% rebaudioside D, and about 35 to 81% rebaudioside M, each as a percentage of the total glycosides in the sweetener composition.

2. The sweetener composition of claim 1, comprising 5 to 10% rebaudioside A.

3. (canceled)

4. The sweetener composition of claim 1, comprising 8 to 15% rebaudioside B.

5. (canceled)

6. The sweetener composition of claim 1, comprising 8 to 40% rebaudioside D.

7. The sweetener composition of claim 1, comprising 12 to 35% rebaudioside D.

8. (canceled)

9. (canceled)

10. The sweetener composition of claim 1, comprising 10 to 75% rebaudioside M.

11. The sweetener composition of claim 1, comprising 35 to 70% rebaudioside M.

12. (canceled)

13. (canceled)

14. (canceled)

15. The composition of claim 1, wherein the steviol glycosides provide an SEV of greater than 7.2 at a concentration of 400 ppm in distilled water containing 0.1% citric acid and 0.015% sodium citrate.

16. (canceled)

17. (canceled)

18. A sweetener composition comprising from about 1 to 18% rebaudioside A, about 4 to 25% rebaudioside B, about 3 to 40% rebaudioside D, and about 30 to 81% rebaudioside M, each as a percentage of the total glycosides in the sweetener composition.

19. The sweetener composition of claim 18, comprising 5 to 15% rebaudioside A.

20. (canceled)

21. The sweetener composition of claim 18, comprising 5 to 20% rebaudioside B.

22. (canceled)

23. The sweetener composition of claim 18, comprising 10 to 35% rebaudioside D.

24. (canceled)

25. (canceled)

26. The sweetener composition of claim 18, comprising 35 to 75% rebaudioside M.

27. The sweetener composition of claim 18, comprising 40 to 70% rebaudioside M.

28. (canceled)

29. (canceled)

30. (canceled)

31. The sweetener composition of claim 18 wherein the steviol glycosides provide an SEV of greater than 7.2 at a concentration of 400 ppm in distilled water containing 0.1% citric acid and 0.015% sodium citrate.

32. (canceled)

33. (canceled)

34. (canceled)

35. (canceled)

36. A food composition comprising the sweetener composition of claim 1.

37. A beverage composition comprising the sweetener composition of claim 1.

38. A rebaudioside ABDM composition comprising from 10% to 50% rebaudioside D and from 50% to 90% rebaudioside M (of the total rebaudioside D and rebaudioside M in the rebaudioside ABDM composition), and wherein the combination of rebaudioside D and rebaudioside M makes up at least 80% of the rebaudioside ABDM composition.

39. The rebaudioside ABDM composition according to claim 38, comprising from 38% to 50% rebaudioside D and from 50% to 63% rebaudioside M (of the total rebaudioside D and rebaudioside M in the Reb ABDM composition)

40. A rebaudioside ABDM composition comprising from 18% to 40% rebaudioside D and from 60% to 82% rebaudioside M (of the total rebaudioside D and rebaudioside M in the rebaudioside ABDM composition), and wherein the combination of rebaudioside D and rebaudioside M makes up at least 80% of the rebaudioside ABDM composition.

41. The rebaudioside ABDM composition according to claim 40, comprising from 22% to 38% rebaudioside D and from 62% to 78% rebaudioside M (of the total rebaudioside D and rebaudioside M in the rebaudioside ABDM composition).
